(19) United States
(12) Patent Application Publication
(10) Pub. No.: US 2007/0256556 A1
(43) Pub. Date: Nov. 8, 2007

(54) Pump having double reverse seal to eliminate leaking and binding

(75) Inventor: David Rawlings, Sound Beach, NY (US)

Correspondence Address: HOFFMANN & BARON, LLP, 6900 JERICHO TURNPIKE, SYOSSET, NY, 11791, US

(73) Assignee: Fluid Metering Inc.

(21) Appl. No.: 11/799,978

(22) Filed: May 3, 2007

Related U.S. Application Data
(60) Provisional application No. 60/798,234, filed on May 5, 2006.

(51) Int. Cl. F16J 15/18

(52) U.S. Cl. 92/165 R

(57) ABSTRACT

A seal assembly which generally includes a first annular seal member having a bent lip portion defining a central opening, a second annular seal member having a bent lip portion defining a central opening and an annular spacer sandwiched between the first and second seal members, wherein the lip portions of the first and second seal members are bent in an inward direction toward one another.

### CROSS-REFERENCE TO RELATED APPLICATIONS

This application claims the benefit of U.S. Provisional Application No. 60/798,234, filed on May 5, 2006.

### FIELD OF THE INVENTION

The present invention relates to a liquid pump having an improved piston seal that eliminates leaking and binding.

### BACKGROUND OF THE INVENTION

The special attributes of a valveless metering pump are well documented and devices employing the designs disclosed in the prior art are used in a wide range of applications. These applications can involve a broad range of fluids, both liquid and gaseous and pumping conditions can vary considerably in terms of flow, pressure, and numerous other characteristics.

At the core of this technology is a cylindrical piston, generally made of ceramic, disposed axially within the bore of a cylinder, also generally made of ceramic. The ceramic might be aluminum oxide, zirconia or other suitable material. Additionally, there are instances where steel, carbon and even plastic materials are employed. In any event, a key feature of these two components is that they are very closely fitted to each other. Clearance is often less than 50 millionths of an inch between the outside surface of the piston and the bore wall of the cylinder. This close fitting relationship is necessary for proper functioning of the pump and considerable expertise for production of these components has been accumulated in the industry.

Such pumps, however, often experience problems in two general areas: leakage and binding. Once each has been explained, the difficulties encountered in simultaneously solving both problems will be seen as the central area of difficulty which the present invention resolves.

Under most circumstances, the close fitting relationship between the piston and the cylinder serves to keep particles which might be suspended in the pumped fluid outside of the clearance gap. Such particles might include dirt, slurry elements, or even abrasive compounds. Particles which venture into the gap are quickly crushed by the shearing action of the extremely hard ceramic material used in the construction of the piston and cylinder.

In spite of the tiny clearances within the pump, a small amount of pumped fluid inevitably works its way up the moving piston and ultimately arrives at the opening where the piston enters its mating cylinder. This fluid will then begin dripping out of the pump unless additional sealing means is employed to prevent this leakage.

An unusual characteristic of such pump designs is that sealing means must accommodate both rotational and reciprocating motion of the piston. Seal manufacturers, when approached for suggestions on which of their products would be most suitable for sealing a moving shaft, will inquire as to whether the seal will be used with a rotating shaft or a reciprocating shaft. The reason for such inquiry is that sealing against a rotating shaft generally requires a different product than sealing against a reciprocating shaft. Related prior art which teaches methods for sealing pump shafts does not usually deal with this troubling combination of motions.

The sealing method most often used in such pumps utilizes a lip seal squeezed in a stationary sealing arrangement against the outside face of the cylinder. Generally, the lip seal is arranged to have its sealing lip disposed towards the cylinder opening. The role of this seal is intended to be that of preventing fluid leakage. Sealing action occurs between the sealing lip and the moving piston surface with the lip contributing to seal integrity by promoting a “squeegee” action while also responding to increases in fluid pressure by squeezing harder on the piston surface.

When high pressures on the outlet port of the pump are encountered, the sealing arrangement described above can fail to completely resist leaks. This situation has been addressed with a special pressure relieving slot previously known and often referred to as a “scavenger” slot. The slot arrangement puts the annular space between the lip seal and the cylinder in direct, unimpeded fluid communication with the inlet port of the pump. The result of this “scavenger” slot is that fluid pressure driving leakage past the lip seals can never exceed pressure at the inlet.

The second troublesome tendency of such conventional pumps is to seize or bind, which has been found, in some cases, to be caused by debris from seal wear. The seals most often used are fabricated from a special material consisting of a network of PTFE fibers captured in a ceramic matrix. As the piston translates and rotates against the seal lip, thin strands of PTFE fibers are inevitably torn out of the matrix. Examination of seized pumps reveals fragments of fibers on the various surfaces and also in shiny patches on portions of the piston which ride inside the cylinder bore. The molecular structure of the PTFE fibers is such that they can be drawn down extremely thin, hence the wide use of PTFE pipe sealing tape which takes advantage of this almost unlimited accommodation to be pulled thin without breaking.

The reciprocating/rotating motion of the piston as it enters and exits the cylinder bore is ideally suited to pull any available PTFE strands into the narrow clearance between piston and bore. These stretched-out strands are then squeezed and spread almost like a paste on a patch of the piston surface, gradually building up on one side and pushing the piston off of one wall of the cylinder bore. This building up on one side causes the clearance between piston and cylinder bore near the patch to increase allowing additional PTFE strands to join the forming patch. Ultimately, there is no longer any clearance on the opposite side and the piston is driven, ceramic surface-to-ceramic surface, hard up against the bore wall opposite to the growing PTFE patch. This causes the piston to seize or bind and the pump to become inoperable.

Careful microscopic examination of the components in a seized pump reveals the findings described above. Close observation of the lip seals removed from these pumps reveal the surprising discovery that PTFE debris is far more prevalent on one side of the seal than on the other side. The side with more debris is always the side having the lip extending outwards from the seal face. The side with little or no debris is always the side with the lip diving into the seal face.

In direct contradiction to the seal orientation usually employed, attempts have been made to orient the lip to face away from the cylinder. This allowed the lip of the seal to preferentially urge any seal debris out of the pump instead of urging it into the pump. Pumps built with this seal arrangement are much less likely to experience the seizing problem caused by seal debris.

However, the difficulty arises when these two solutions are combined in one pump and that pump will be utilized in a fluid circuit having positive pressures on both the inlet and outlet ports. Such circuits are very common in the field of metering pumps and until the concepts described in this invention were discovered, scavenger slot pumps could not be used along with outward facing lip seals.

Specifically, orientation of the seal lip towards the outside does a good job of keeping seal debris out of the close clearance area but this means that the seal does a very poor job of holding back fluid leakage. So long as the inlet port pressure is at or below atmospheric pressure, the scavenger slot will relieve the lip seal from any responsibility to hold back escaping of fluid at the cylinder side of the seal. However, once pressure is applied to the inlet port, the scavenger slot directly communicates this pressure to the cylinder side of the seal and leakage is inevitable. The outward facing lip seal cannot hold back the fluid.

Other attempts have been made to address the problems described herein. U.S. Patent Application Publication No. US-2005-0276705-A1 describes a surface treatment of PTFE deposition on the piston surfaces and cylinder bore as well as surface roughening of seal mating areas on the piston to address pump seizing problems. The surface treatments described in this publication have been shown to be highly successful in reducing the bonding of crystals to treated surfaces and also reducing the amount of seal wear, thereby reducing the incidence of seizing. These enhancements are even more effective when combined with the present invention.

Additionally, special cup-style gland seals have been employed to address leakage problems. Cup-style gland seals have been shown to be effective against leakage but require considerable driving torque such that the motors most often used are incapable of overcoming this added drag.

Accordingly, it would be desirable to provide a simply designed seal assembly for a metering pump which both keeps seal debris out of the pump and also holds back fluid leakage, particularly in applications where the inlet and outlet of the pump both experience positive pressures.

### SUMMARY OF THE INVENTION

The present invention is a seal assembly which generally includes a first annular seal member having a bent lip portion defining a central opening, a second annular seal member having a bent lip portion defining a central opening and an annular spacer sandwiched between the first and second seal members, wherein the lip portions of the first and second seal members are bent in an inward direction toward one another.

In a preferred embodiment, the first seal member, the second seal member and the spacer define an annular reservoir chamber theretbetween and this chamber is preferably filled with a lubricating grease. Also, the first seal member, the second seal member and the spacer are preferably made from a ceramic loaded polytetrafluoroethylene (PTFE) material.

The seal assembly further preferably includes a gland nut for attaching the seal assembly to an open end of a pump. The first and second seal members and the spacer are received within the gland nut and are compressed by the gland nut against the open end of the pump.

The present invention further involves a liquid pump, which generally includes a pump housing having an end face and a central longitudinal bore open at the end face, a pump piston axially slidable within the housing bore and extending outwardly from the housing end face, a seal assembly disposed at the housing end face and a gland nut for attaching the seal assembly to the end face of the housing. The seal assembly includes a first annular seal member having a lip portion bent away from the housing end face, a second annular seal member having a lip portion bent toward the housing end face, and an annular spacer sandwiched between the first and second seal members. The lip portions of the first and second seal members define an opening for receiving the pump piston in close sliding contact.

As a result of the present invention, a seal assembly is provided which significantly reduces leakage and binding problems while allowing for the use of small, inexpensive, low torque driving motors.

A preferred form of the seal assembly, as well as other embodiments, objects, features and advantages of this invention, will be apparent from the following detailed description of illustrative embodiments thereof, which is to be read in conjunction with the accompanying drawings.

### BRIEF DESCRIPTION OF THE DRAWINGS

FIG. 1 is a cross-sectional view of a metering pump of the prior art.

FIG. 2 is an exploded perspective view of the pump and double reverse seal assembly formed in accordance with the present invention.

FIG. 3 is a cross-sectional view of the pump and double reverse seal assembly formed in accordance with the present invention.

FIG. 4 is an enlarged cross-sectional view of the double reverse seal assembly shown in FIG. 3.

FIG. 5 is cut-away perspective view of one of the lip seals of the double reverse seal assembly of the present invention.

FIG. 6 is an enlarged partial cut-away view of the double reverse seal assembly of the present invention.

### DETAILED DESCRIPTION OF THE PREFERRED EMBODIMENTS

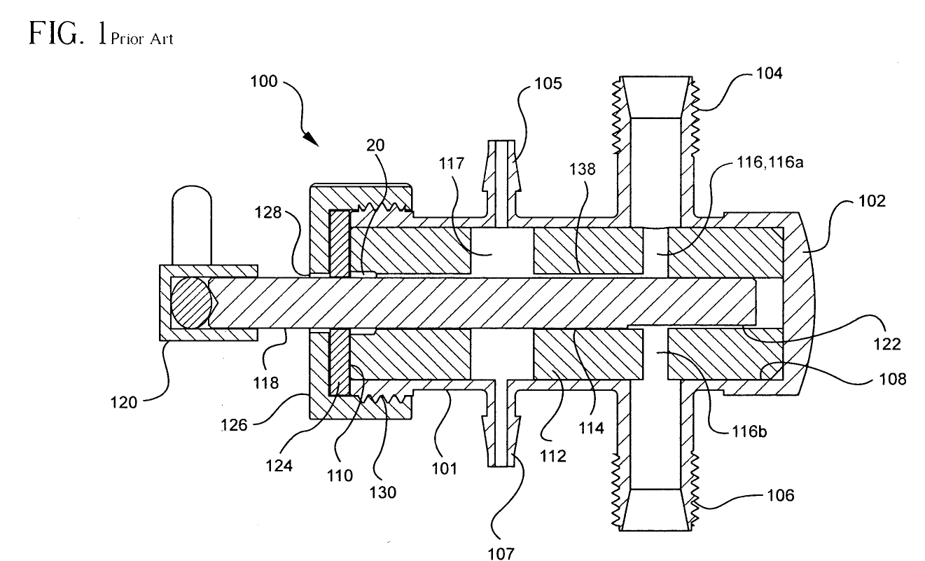

FIG. 1 shows a typical metering pump 100 of the prior art. The pump 100 generally includes a pump housing 101 and a piston 118. The pump housing 101 preferably includes a plastic pump casing 102 having an inlet port 104 and an outlet port 106. The pump casing 102 can also include a wash-water inlet port 105 and a wash-water outlet port 107.

The pump casing 102 defines a cylindrical chamber 108 having an open end 110. Received in the cylindrical chamber 108 is a ceramic piston liner 112 having a central longitudinal bore 114 and a transverse bore 116 communicating with the longitudinal bore. The first transverse bore 116 includes an inlet portion 116a fluidly communicating with the inlet port 104 of the pump casing 102 and an outlet portion 116b fluidly communicating with the outlet port 106 of the pump casing so that a liquid can be pumped from the inlet port, through the liner, to the outlet port in a manner as will be described below. The liner 112 can further include a second transverse bore 117 communicating with the longitudinal bore 114 and the wash-water inlet and outlets 105 and 107.

The pump 100 further includes a ceramic piston 118 axially and rotatably slidable within the central bore 114 of the piston liner 112. One end of the piston 118 extends out of the open end 110 of the pump casing 102 and includes a coupling 120 for engagement with a motor. At its opposite end, the piston 118 is formed with a relieved portion 122 disposed adjacent the transverse bore 116 of the pump liner. As will be described below, the relieved portion 122 is designed to direct fluid into and out of the pump 100.

A conventional seal assembly 124 is provided at the open end 110 of the pump casing 102 to seal the piston 118 and the pump chamber 108. The conventional seal assembly 124 typically includes a resilient wiper-type, annular seal member having an inner diameter in close sliding relationship with the outer diameter of the piston 118. The conventional seal assembly 124 is retained at the open end 110 of the pump casing 102 by a gland nut 126 having a central opening 128 to receive the piston 118. The gland nut 126 is preferably attached to the pump casing 102 with a threaded connection 130 provided therebetween.

In operation, a motor (not shown in FIG. 1) drives the piston 118 to axially translate and rotate within the central bore 114 of the piston liner 112. In order to draw liquid into the transverse bore 116 from the inlet port 104, the piston 118 is rotated as required to align the relieved portion 122 with the inlet port. The piston 118 is then drawn back as required to take in the desired volume of liquid into the central bore 114 of the pump liner 112. Withdrawal of the piston 118 produces a negative pressure within the inlet portion 116a of the transverse bore 116, which draws in liquid from the inlet port 104. The piston 118 is then rotated to align the relieved portion 122 with the outlet port 106 of the pump casing 102. Finally, the piston 118 is driven forward the required distance to force liquid into the outlet port 106 via the outlet portion 116b of the transverse bore 116 to produce the desired discharge flow.

When pumping liquids with the pump shown in FIG. 1, some of the liquid will invariably seep into the space between the piston 118 and the piston liner 112. To provide a path for this liquid, the liners 112 of some pumps of the prior art are further formed with a pressure relief slot 138 (also termed a “scavenger slot”). The pressure relief slot 138 communicates with and extends longitudinally along the central bore 114 of the liner 112 from the open end 110 of the liner to the inlet portion 116a of the transverse bore 116. A counter bore 20 is further preferably formed in the end face 18 of the cylindrical liner 112 surrounding the central bore 114. The counter bore 20 is in fluid communication with the scavenger slot 138 and provides an additional reservoir for storing liquid.

The pressure relief slot 138 thus formed facilitates fluid flow back to the inlet portion 116a of the transverse bore 116 when a negative pressure is created at the inlet portion. In other words, a negative pressure created at the inlet portion 116a of the transverse bore 116 tends to draw the liquid surrounding the piston 118 back to the inlet portion via the pressure relief slot 138.

However, in certain pumping applications, it is desirable to have a positive pressure applied at the inlet portion 116a of the transverse bore. In these situations, fluid in the scavenger slot 138, as well as the fluid trapped between the outside of the piston 118 and the inside of the liner 112 will be pushed in a direction toward the open end 110 of the pump casing 102. Thus, the seal assembly must be able to prevent this fluid from leaking out of the pump 100.

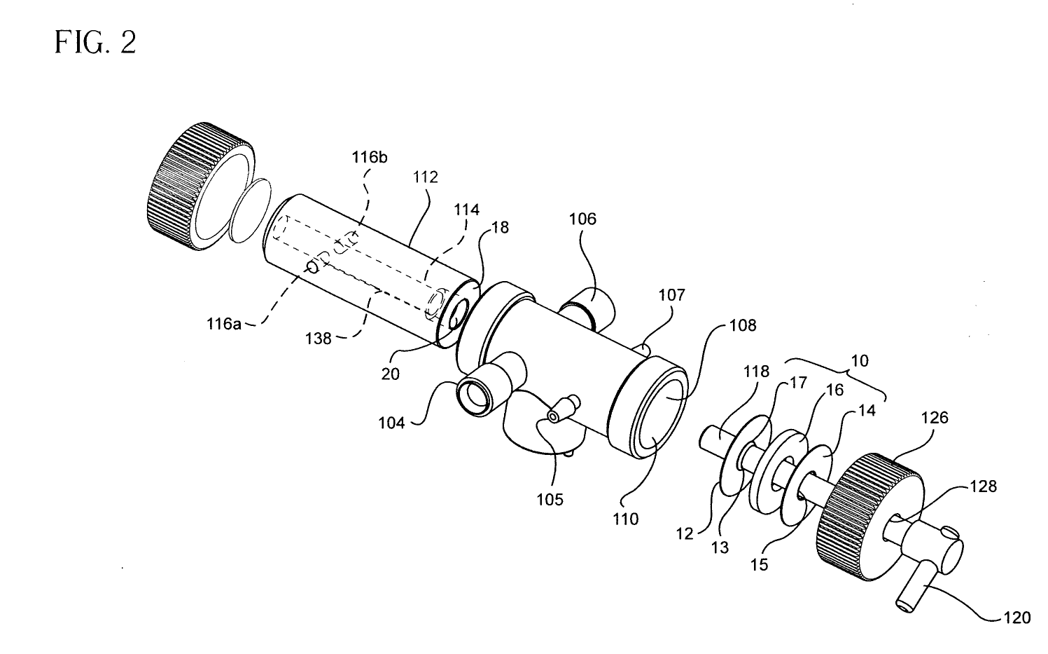

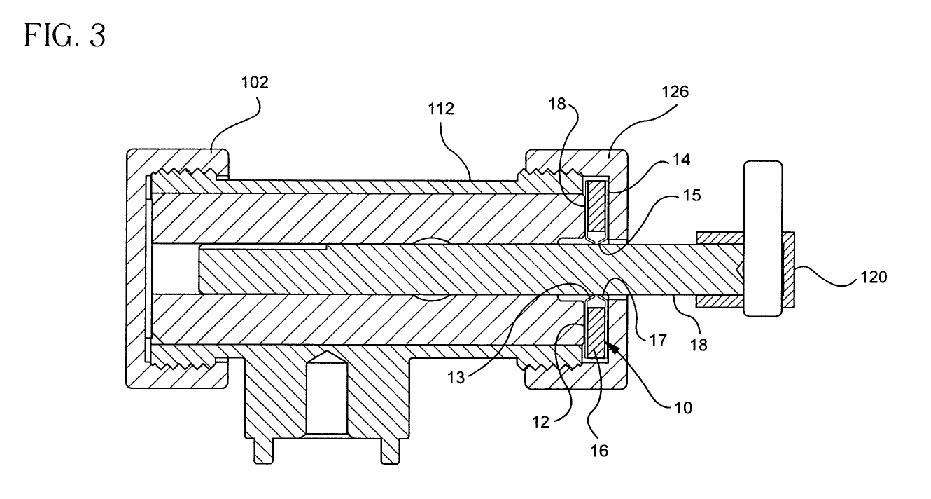

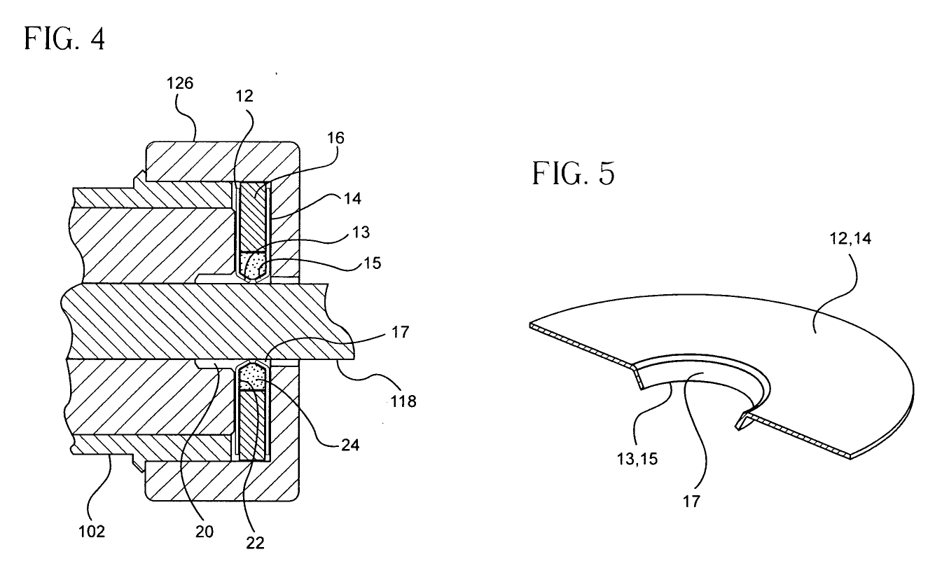

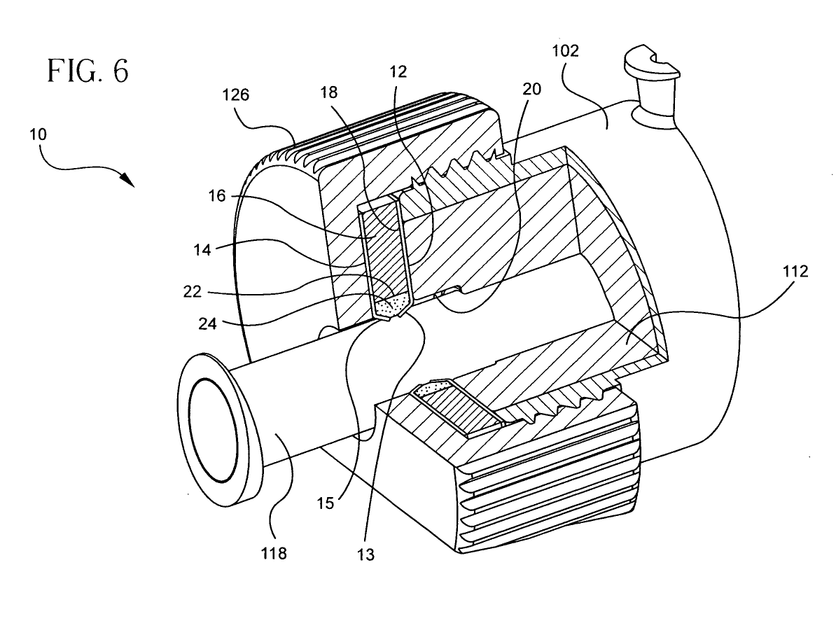

The present invention contemplates a seal arrangement which prevents both sealing and binding problems. FIGS. 2-6 illustrate the construction details of the seal assembly of the present invention, which will be explained more fully below, wherein like elements have retained their same reference numerals.

The lip seal assembly 10 of the present invention includes a first lip seal member 12 having a lip portion 13 facing away from the cylinder liner 112 and a second lip seal member 14 having a lip portion 15 facing inward toward the liner. More particularly, the lip seal members 12 and 14 are semi-rigid to rigid, thin, disk-shaped elements that are preferably made from a ceramic loaded polytetrafluoroethylene (PTFE), such as Rulon A®. The outer diameter of each circular lip seal member 12, 14 is sized to generally match the outer diameter of the pump casing 102. Each lip seal member 12, 14 further defines a central circular opening 17 having an inner diameter matching the outer diameter of the pump piston 118.

The lip portion 13, 15 of each lip seal member 12, 14 is formed by bending a continuous portion of the member surrounding the central opening 17 at an angle with respect to the remainder of the member. The lip portion 13, 15 of each lip seal member is preferably bent or deflected at an angle of between thirty and seventy-five degrees.

Sandwiched between the lip seal members 12 and 14 is a relatively thick PTFE washer 16. The annular washer 16 has an outer diameter matching the outer diameter of the seal members 12, 14 and an inner diameter which is larger than the inner diameter defining the central opening 17 of the seal members. Thus configured, the inner diameter of the washer 16 and the two seal members 12, 14 define an annular debris reservoir 22, the function of which will be described in further detail below. When the gland nut 126 is threaded onto the cylinder case 102, the seal members 12 and 14 and washer 16 are squeezed into sealing contact with the end face 18 of the cylinder liner 112 and the cylinder case 102.

Thus, it can now be seen that the two lip seal members 12 and 14 are called upon to play entirely different roles. By virtue of its outwardly bent lip portion 13, the first or inner lip seal member 12 performs the task of urging eroded seal debris away from the piston/cylinder clearance. When fluid pressure builds up in the annular cavity 20 behind the lip seal members 12 and 14, fluid squeezes past the out-turned lip 13 of the first lip seal 12 and is then confronted with the inwardly turned lip 15 of the second or outer lip seal member 14. At this point the fluid is effectively blocked from leaking outside of the pump. Seal debris, meanwhile, which may be generated by both lip seal members 12 and 14, are blocked from entry into the pump by the outwardly bent lip portion 13 of the first lip seal member 12. The inwardly facing lip 15 of the second seal member 14 also prevents this debris from passing outside of the pump so that debris is trapped in a debris reservoir 22 formed between the seal members 12 and 14 and inside the bore of the washer 16.

An added benefit of this construction is associated with problems that arise from pumping liquids which crystallize when exposed to air. This crystallization occurs after the liquid evaporates and leaves behind the previously dissolved substance. Examples are saline and sodium bicarbonate solutions. The present invention works to solve this problem by virtue of the fact that the two seal members 12, 14 work in concert to constantly urge solution into the space between the seals where evaporation is discouraged.

A further advantage of this invention is that the annular space 22 created between the seals 12 and 14 and within the bore of the spacer washer 16 provides a reservoir which can be filled with a suitable grease 24 to lubricate the seal area. Examples of such grease that might be used herein include petroleum jelly, medical grade silicone grease and Rheolube 365™, produced by NYE Lubricants, Inc. of New Bedford, Mass. This grease 24 will be prevented from joining the pumped liquid by the inner seal member 12 and also be prevented from escaping outside the pump by the outer seal member 14. Moreover, the presence of grease 24 in this area does not inhibit the debris trapping function of the reservoir 22 and it has been also shown to further obviate against crystallization problems.

Although preferred embodiments of the present invention have been described herein with reference to the accompanying drawings, it is to be understood that the invention is not limited to those precise embodiments and that various other changes and modifications may be affected herein by one skilled in the art without departing from the scope or spirit of the invention, and that it is intended to claim all such changes and modifications that fall within the scope of the invention.

What is claimed is:

1. A seal assembly comprising:
a first annular seal member having a bent lip portion defining a central opening;
a second annular seal member having a bent lip portion defining a central opening; and
an annular spacer sandwiched between said first and second seal members,
wherein said lip portions of said first and second seal members are bent in an inward direction toward one another.

2. A seal assembly as defined in claim 1, wherein said first seal member, said second seal member and said spacer define an annular reservoir chamber therebetween.

3. A seal assembly as defined in claim 2, further comprising a lubricating grease contained within said reservoir chamber.

4. A seal assembly as defined in claim 1, further comprising a gland nut for attaching the seal assembly to an open end of a pump, said first and second seal members and said spacer being received within said gland nut and being compressed by said gland nut against the open end of the pump.

5. A seal assembly as defined in claim 1, wherein said first and second seal members are made from a ceramic loaded polytetrafluoroethylene (PTFE) material.

6. A seal assembly as defined in claim 1, wherein said spacer is made from a polytetrafluoroethylene (PTFE) material.

7. A liquid pump comprising:
a pump housing having an end face and a central longitudinal bore open at said end face;
a pump piston axially slidable within said housing bore and extending outwardly from said housing end face;
a seal assembly disposed at said housing end face, said seal assembly including a first annular seal member having a lip portion bent away from said housing end face, a second annular seal member having a lip portion bent toward said housing end face, and an annular spacer sandwiched between said first and second seal members, said lip portions defining an opening for receiving said pump piston in close sliding contact; and
a gland nut for attaching said seal assembly to said end face of said housing.

8. A liquid pump as defined in claim 7, wherein said first seal member, said second seal member and said spacer define an annular reservoir chamber therebetween.

9. A liquid pump as defined in claim 8, wherein said seal assembly further comprises a lubricating grease contained within said reservoir chamber.

10. A liquid pump as defined in claim 7, wherein said gland nut compresses said seal assembly against said end face of said housing.

11. A liquid pump as defined in claim 7, wherein said first and second seal members are made from a ceramic loaded polytetrafluoroethylene (PTFE) material.

12. A liquid pump as defined in claim 7, wherein said spacer is made from a polytetrafluoroethylene (PTFE) material.

13. A liquid pump as defined in claim 7, wherein said pump housing further comprises:
an inlet port;
an outlet port;
a transverse bore including an inlet portion extending between said inlet port and said central bore and an outlet portion extending between said central bore and said outlet port; and
a pressure relief slot formed in said central bore between said inlet portion of said transverse bore and said end face of said housing.

14. A liquid pump as defined in claim 13, wherein said pump housing further includes a counter bore formed in said end face adjacent said seal assembly for storing a liquid, said pressure relief slot extending from said inlet portion of said transverse bore to said counter bore.
